(19) United States
(12) Patent Application Publication
(10) Pub. No.: US 2020/0349582 A1
(43) Pub. Date: Nov. 5, 2020

(54) METHOD AND SYSTEM FOR ADDRESSING USER DISCONTENT OBSERVED ON CLIENT DEVICES

(71) Applicant: EMC IP Holding Company LLC, Hopkinton, MA (US)

(72) Inventors: Amihai Savir, Sansana (IL); Assaf Natanzon, Tel Aviv (IL); Avitan Gefen, Lehavim (IL)

(21) Appl. No.: 16/402,822

(22) Filed: May 3, 2019

(51) Int. Cl. G06Q 30/00; G06N 20/00

(52) U.S. Cl. CPC G06Q 30/016; G06N 20/00

(57) ABSTRACT

A method and system for processing user feedback on client devices. Specifically, the method and system disclosed herein entail aggregating and sampling a feature set pertinent to the classification and/or prediction of user dissatisfaction with their respective client devices. Following the derivation of user discontent scores based on anomaly detection and machine learning methodologies, one or more actions may be performed to address and/or alleviate the observed user discontent.

### BACKGROUND

Satisfaction surveys are a well-established method to get user opinion regarding products and/or services. Unfortunately, users are not always willing to put forth the time and effort to complete these surveys.

### BRIEF DESCRIPTION OF DRAWINGS

FIG. 1A shows a system in accordance with one or more embodiments of the invention.

FIG. 1B shows a user satisfaction agent in accordance with one or more embodiments of the invention.

FIG. 2 shows a flowchart describing a method for generating labeled feature set information samples in accordance with one or more embodiments of the invention.

FIG. 3 shows a flowchart describing a method for optimizing a learning model in accordance with one or more embodiments of the invention.

FIG. 4 shows a flowchart describing a method for processing sample analysis requests in accordance with one or more embodiments of the invention.

FIG. 5 shows a flowchart describing a method for addressing user discontent in accordance with one or more embodiments of the invention.

FIG. 6 shows a computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

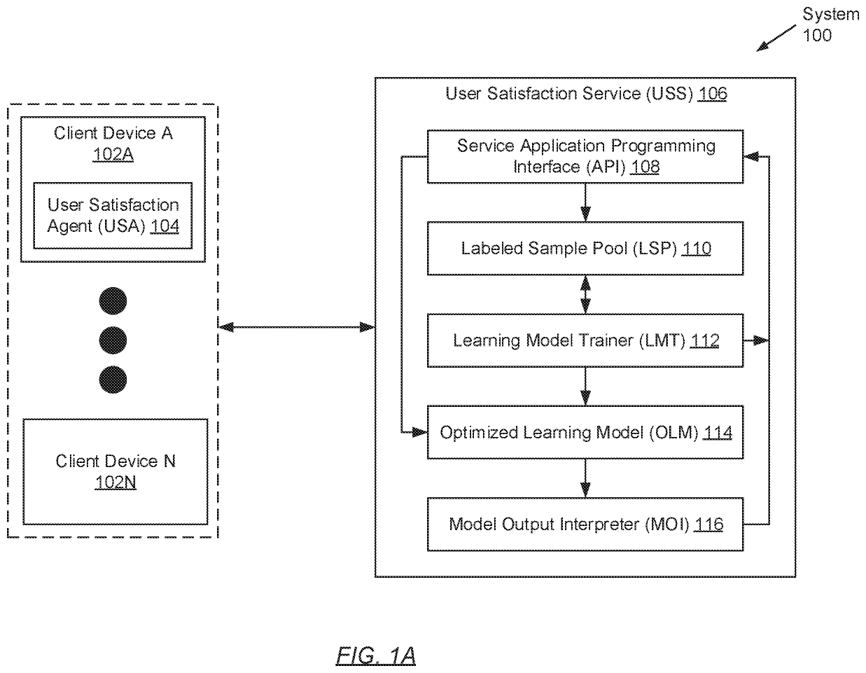

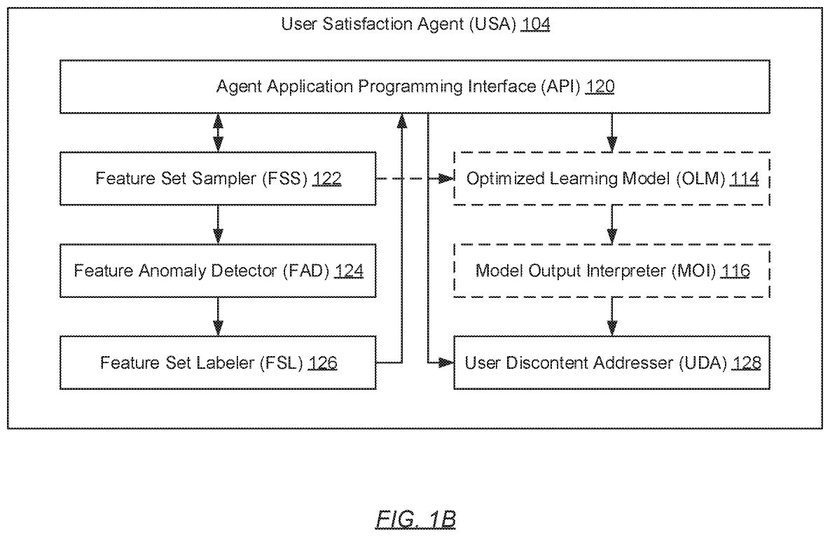

In the following description of FIGS. 1A-6, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for addressing user discontent observed on client devices. Specifically, one or more embodiments of the invention entails aggregating and sampling a feature set pertinent to the classification and/or prediction of user dissatisfaction (or discontent) with their respective client devices. Following the derivation of user discontent scores based on anomaly detection and machine learning methodologies, one or more actions may be performed to address and/or alleviate the observed user discontent.

FIG. 1A shows a system in accordance with one or more embodiments of the invention. The system (100) may include one or more client devices (102A-102N) operatively connected to a user satisfaction service (USS) (106). Each of these system (100) components is described below.

In one embodiment of the invention, the client device(s) (102A-102N) may operatively connect with the USS (106) through a network (not shown) (e.g., a local area network (LAN), a wide area network (WAN) such as the Internet, a mobile network, etc.). The network may be implemented using any combination of wired and/or wireless connections. Further, the network may encompass various interconnected, network-enabled components (or systems) (e.g., switches, routers, gateways, etc.) that may facilitate communications between the client device(s) (102A-102N) and the USS (106). Moreover, the client device(s) (102A-102N) and the USS (106) may communicate with one another using any combination of wired and/or wireless communication protocols.

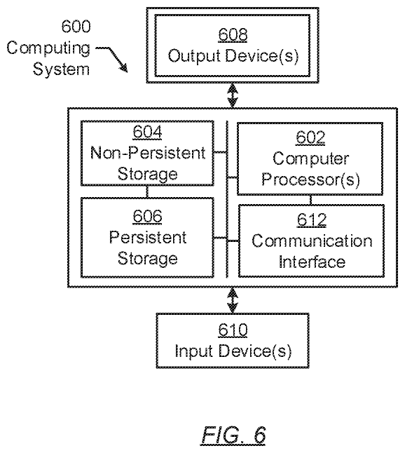

In one embodiment of the invention, a client device (102A-102N) may represent any physical appliance or computing system designed and configured to receive, generate, process, store, and/or transmit data. One of ordinary skill will appreciate that a client device (102A-102N) may perform other functionalities without departing from the scope of the invention. Examples of a client device (102A-102N) may include, but are not limited to, a desktop computer, a tablet computer, a laptop computer, a server, a mainframe, or any other computing system similar to the exemplary computing system shown in FIG. 6.

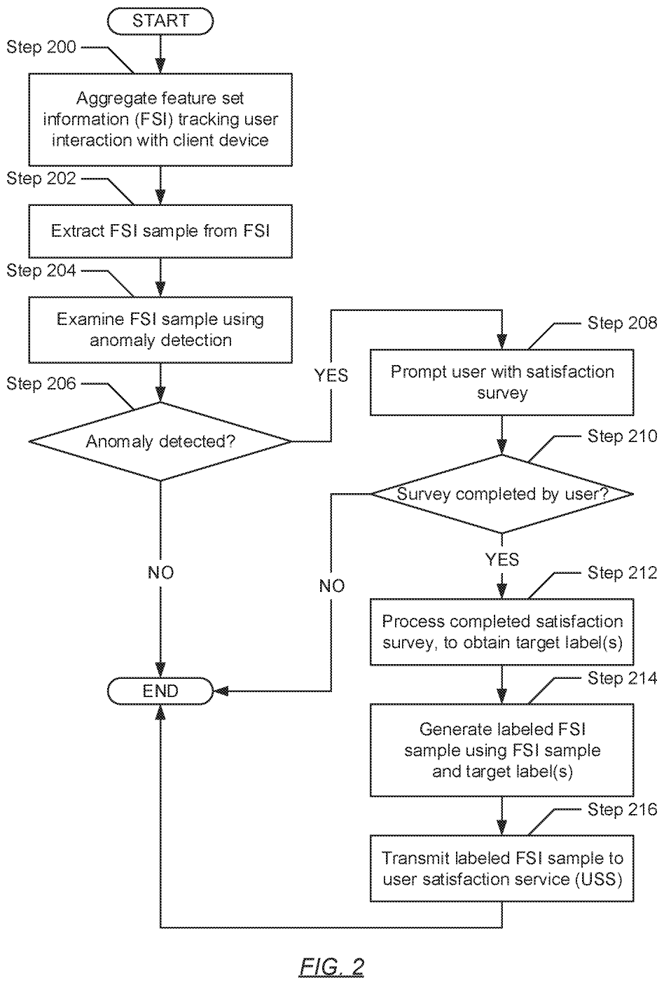

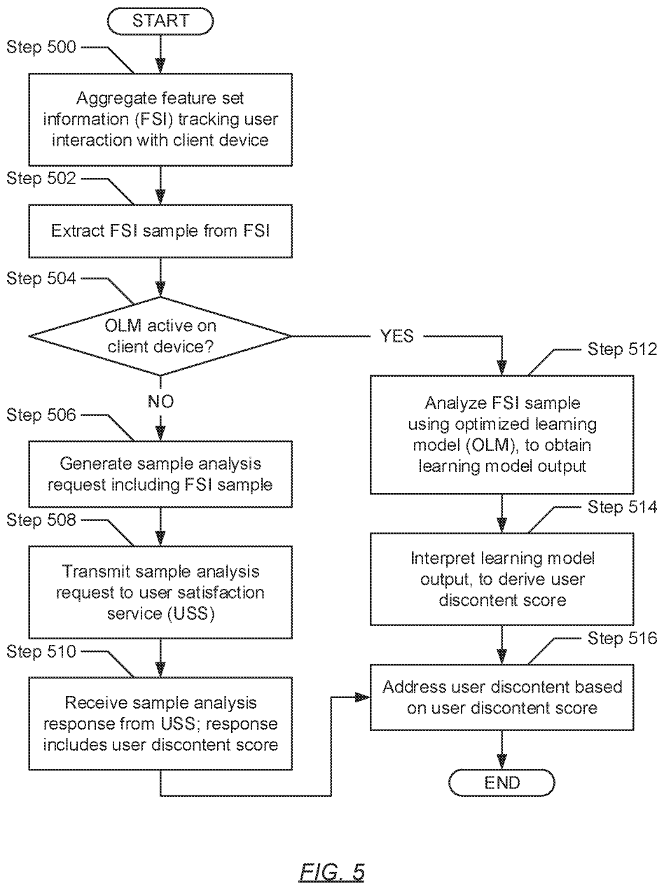

In one embodiment of the invention, a client device (102A-102N) may include a user satisfaction agent (USA) (104). The USA (104) may refer to a computer program, which may execute on the underlying hardware of a client device (102A-102N), and may be designed and configured to generate labeled feature set information (FSI) samples (see e.g., FIG. 2) and address user discontent (see e.g., FIG. 5) in accordance with one or more embodiments of the invention. The USA (104) is described in further detail below with respect to FIG. 1B.

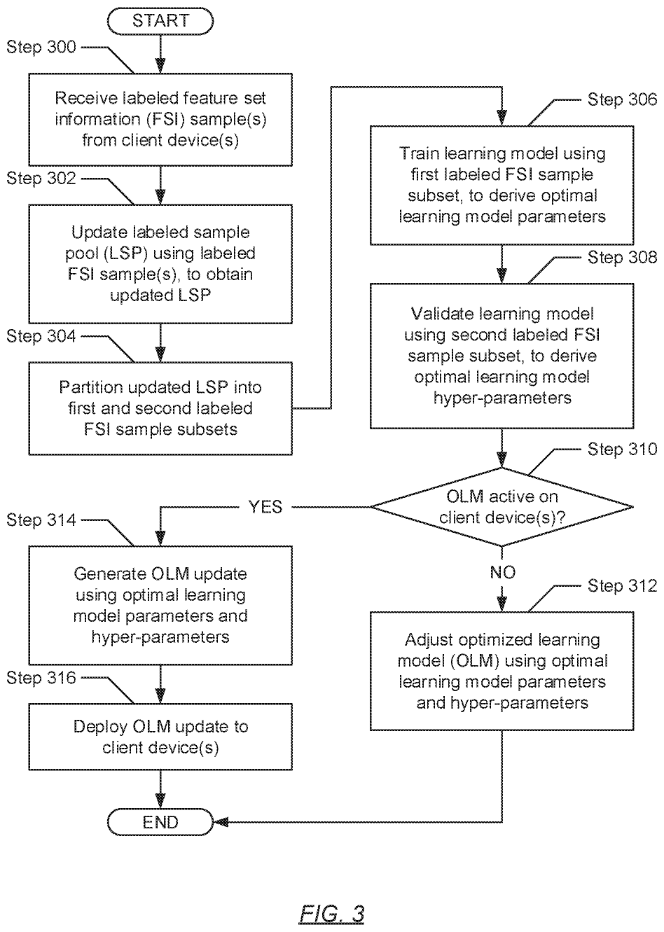

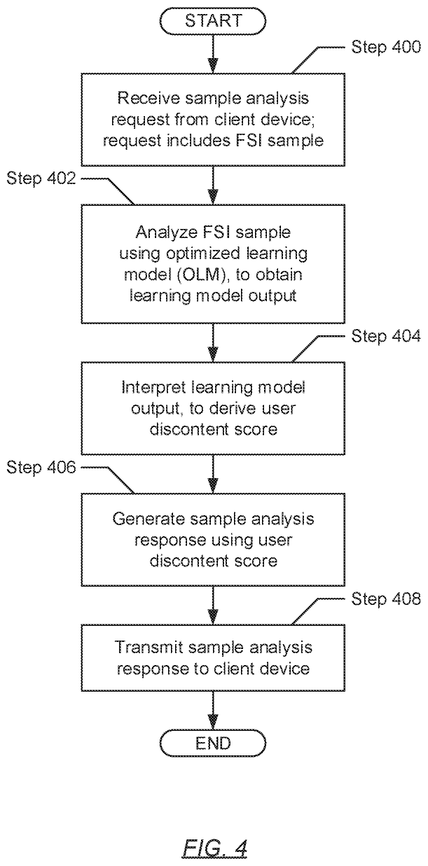

In one embodiment of the invention, the USS (106) may represent a back-end system that supports USA (104) (i.e., front-end application) functionality on the client device(s) (102A-102N). To that extent, the USS (106) may be designed and configured to optimize a learning model (see e.g., FIG. 3) and process sample analysis requests (see e.g., FIG. 4) in accordance with one or more embodiments of the invention. The USS (106) may be implemented using one or more servers (not shown). Each server may be a physical server, which may reside in a datacenter, or a virtual server, which may reside in a cloud computing environment. Additionally or alternatively, the USS (106) may be implemented using one or more computing systems similar to the exemplary computing system shown in FIG. 6. Furthermore, the USS (106) may include a service application programming interface (API) (108), a labeled sample pool (LSP) (110), a learning model trainer (LMT) (112), an optimized learning model (OLM) (114), and a model output interpreter (MOI) (116). Each of these USS (106) subcomponents is described below.

In one embodiment of the invention, the service API (108) may refer to a set of subroutine definitions, protocols, and/or tools for enabling communications between the USS (106) and the USA (104) on the client device(s) (102A-102N). The service API (108) may be implemented using USS (106) hardware, software executing thereon, or a combination thereof. Further, the service API (108) may include functionality to: receive one or more labeled FSI samples from the USA (104) on any client device (102A-102N); update the LSP (110) using the received labeled FSI sample(s); obtain optimal learning model parameters and hyper-parameters from the LMT (112); generate OLM (114) updates using obtained optimal learning model parameters and hyper-parameters; deploy (i.e., transmit) generated OLM (114) updates to the USA (104) on the client device(s) (102A-102N); receive sample analysis requests from the USA (104) on any client device (102A-102N); extract FSI samples from received sample analysis requests; provide extracted FSI samples to the OLM (114); obtain user discontent scores from the MOI (116); generate sample analysis responses using obtained user discontent scores; and transmit generated sample analysis responses to the USA (104) on appropriate client device(s) (102A-102N). One of ordinary skill will appreciate that the service API (108) may perform other functionalities without departing from the scope of the invention. By way of an example, the service API (108) may be implemented as a web API, which may be accessed through an assigned web address (e.g., a uniform resource locator (URL)) and a WAN (e.g., Internet) connection.

In one embodiment of the invention, the LSP (110) may refer to a collection of labeled FSI samples (described below) aggregated from the client device(s) (102A-102N). The LSP (110) may be maintained as a data source from which learning model training and validation sets may be generated (see e.g., FIG. 3). Further, the LSP (110) may be consolidated in one or more physical storage devices (not shown) residing on the USS (106). Each physical storage device may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the LMT (112) may refer to a computer program, which may execute on the underlying hardware of the USS (106), and may be designed and configured to optimize (i.e., train) one or more learning models. A learning model may generally refer to a machine learning algorithm (e.g., a neural network, a decision tree, a support vector machine, a linear regression predictor, etc.) that may be used in data classification, data prediction, and other forms of data analysis. To that extent, the LMT (112) may include functionality to: partition the LSP (110) into learning model training and validation sets; train the learning model(s) using the training sets, thereby deriving optimal learning model parameters; validate the learning model(s) using the validation sets, thereby deriving optimal learning model hyper-parameters; and provide the derived optimal learning model parameters and hyper-parameters to the service API (108) or, alternatively, adjust the OLM (114) using the derived optimal learning model parameters and hyper-parameters. One of ordinary skill will appreciate that the LMT (112) may perform other functionalities without departing from the scope of the invention.

In one embodiment of the invention, the OLM (114) may refer to a computer program, which may execute on the underlying hardware of the USS (106), and may be designed and configured to implement a machine learning algorithm, which has been optimized through supervised learning. Supervised learning may refer to learning (or optimization) through the analysis of training examples and/or data. Further, the OLM (114) may focus on classifying and/or predicting user discontent with a given client device based on FSI samples from the given client device. To that extent, the OLM (114) may include functionality to: obtain one or more FSI samples; analyze the FSI sample(s) based on the learning model architecture implemented by the OLM (114); produce learning model output(s) based on analyzing the FSI sample(s); provide the produced learning model output(s) to the MOI (116); receive OLM (114) updates including new optimal learning model parameters and hyper-parameters; and adjust the implemented machine learning algorithm using the new optimal learning model parameters and hyper-parameters, thereby implementing an adjusted machine learning algorithm One of ordinary skill will appreciate that the OLM (114) may perform other functionalities without departing from the scope of the invention.

In one embodiment of the invention, the MOI (116) may refer to a computer program, which may execute on the underlying hardware of the USS (106), and may be designed and configured to interpret learning model outputs. To that extent, the MOI (116) may include functionality to: obtain learning model outputs from the OLM (114); interpret obtained learning model outputs to derive user discontent scores; and provide the derived user discontent scores to the service API (108). One of ordinary skill will appreciate that the MOI (116) may perform other functionalities without departing from the scope of the invention.

While FIG. 1A shows a configuration of components, other system (100) configurations may be used without departing from the scope of the invention.

FIG. 1B shows a user satisfaction agent (USA) in accordance with one or more embodiments of the invention. In one embodiment of the invention, the USA (104) may include an agent application programming interface (API) (120), a feature set sampler (FSS) (122), a feature anomaly detector (FAD) (124), a feature set labeler (FSL) (126), and a user discontent addresser (UDA) (128). In another embodiment of the invention, the USA (104) may further include an optimized learning model (OLM) (114) and a model output interpreter (MOI) (116). Each of these USA (104) subcomponents is described below.

In one embodiment of the invention, the agent API (120) may refer to a set of subroutine definitions, protocols, and/or tools for enabling communications between the USA (104) and the USS (106) (see e.g., FIG. 1A) and/or other client device (102A-102N) subcomponents (e.g., operating system (OS) (not shown), computer programs, utilities, etc.). The agent API (120) may be implemented using client device (102A-102N) hardware, software executing thereon, or a combination thereof. Further, the agent API (120) may include functionality to: issue system calls (e.g., service requests) to the operating system (OS) (not shown) that may be executing on the client device (102A-102N), where the systems calls may be directed to accessing client device usage information representative of feature set information (FSI) (described below); provide the client device usage information (or FSI) to the FSS (122); obtain labeled FSI samples from the FSL (126); transmit obtained labeled FSI samples, over a network, to the USS (106); receive OLM updates, including new optimal learning model parameters and hyper-parameters, from the USS (106); provide the new optimal learning model parameters and hyper-parameters to the OLM (114); obtain FSI samples from the FSS (122); generate sample analysis requests using obtained FSI samples; transmitting, over the network, generated sample analysis requests to the USS; receive, as replies to transmitted sample analysis requests, sample analysis responses from the USS; extract user discontent scores enclosed in the received sample analysis responses; and provide the extracted user discontent scores to the MOI (116). One of ordinary skill will appreciate that the agent API (120) may perform other functionalities without departing from the scope of the invention.

In one embodiment of the invention, the FSS (122) may refer to a computer process (i.e., an instance of a computer program—e.g., the USA (104)), which may execute on the underlying hardware of a client device (102A-102N), and may be designed and configured to aggregate and sample feature set information (FSI). FSI may refer to real-time captured data representing a set of features (i.e., measurable properties or characteristics) pertinent to user dissatisfaction (or discontent) classification and/or regression. That is, each feature may refer to a factor (or variable)—observed on the client device—that may, at least in part, cause or exhibit user discontent with the client device. Furthermore, the FSS (122), as briefly mentioned beforehand, may sample FSI and, in doing so, may include functionality to extract FSI samples. An FSI sample may represent a value snapshot of the various features, expressed in the FSI, for a given instance of time. The FSI sample may manifest as an N-dimensional vector or array (i.e., a flat data structure including N elements, where each element stores a numerical value quantifying a respective feature at the given instance of time), where N represents the number of features expressed in the FSI. Moreover, extraction of an FSI sample may transpire based on a chosen periodicity, in response to an event, or through randomization. One of ordinary skill will appreciate that the FSS (122) may perform other functionalities without departing from the scope of the invention.

Examples of these features may include, but are not limited to: (a) a number of client device crashes recorded over a chosen time window, where more client device crashes tend to infer that the client device is not performing well, which leads to user discontent; (b) a number of user-initiated client device restarts recorded over a chosen time window, where more user-initiated client device restarts tend to infer that the client device is not performing well, which leads to user discontent; (c) input device (e.g., keyboard, mouse, etc.) usage patterns (described below) recorded over a chosen time window, where higher usage frequency and/or intensity tend to infer that a user, operating the client device, is stressed or angry, which may indicate user discontent; (d) operating system (OS) response time (i.e., an amount of time the OS may take to respond to a user request for a service on the client device) recorded over a chosen time window, where higher OS response times tend to infer that the user is waiting longer for a service to manifest following a request, which leads to user discontent; and (e) computer processor usage, while executing one or more computer programs, recorded over a chosen time window, where higher computer processor usage tends to infer that the client device is not performing well, which leads to user discontent. One of ordinary skill will appreciate that additional or alternative features may be used in user discontent classification and/or regression without departing from the scope of the invention.

In one embodiment of the invention, the FAD (124) may refer to a computer process (i.e., an instance of a computer program—e.g., the USA (104)), which may execute on the underlying hardware of a client device (102A-102N), and may be designed and configured to examine FSI samples using anomaly detection. Generally, anomaly (or outlier) detection may refer to the identification of abnormal observations, which tend to raise suspicion by differing significantly from a majority of the observations (i.e., normal observations). Usually, an identified anomaly in data (also referred herein as a data anomaly) may exhibit a strong correlation with a problem (e.g., the poor performance of a client device, or the poor mental state of a user, and, therefore, the discontent of the user with the client device). One of ordinary skill will appreciate that the FAD (124) may perform other functionalities without departing from the scope of the invention.

In one embodiment of the invention, the employed anomaly detection technique(s) may be directed to univariate anomaly detection and/or multivariate anomaly detection. Univariate anomaly detection may refer to the identification of data anomalies in a single feature space (i.e., a chosen feature captured by the FSI sample). On the other hand, multivariate anomaly detection may refer to the identification of data anomalies across two or more feature spaces (i.e., two or more chosen features captured by the FSI sample). Examples of univariate or multivariate anomaly detection techniques may include, but are not limited to, methodologies based on z-score or extreme value analysis, probabilistic and statistical modeling, linear regression models, proximity based models, information theory models, and high dimensional sparse data analysis.

In one embodiment of the invention, the FSL (126) may refer to a computer process (i.e., an instance of a computer program—e.g., the USA (104)), which may execute on the underlying hardware of a client device (102A-102N), and may be designed and configured to generate labeled FSI samples. A labeled FSI sample may represent a data container (e.g., a file format) within which a FSI sample and one or more associated target label(s) may be packaged. In turn, a target label may refer to a discrete numerical or categorical value assigned to represent a class (i.e., in classification learning models) or a state (i.e., in regression learning models). Furthermore, in order to derive the target label(s), the FSL (126) may include functionality to prompt the user of (or operating) the client device (102A-102N) with satisfaction surveys. A satisfaction survey may represent a questionnaire, visually presented to the user through the client device, which includes a set of questions directed to gauging user discontent at the given instance in time. Following completion of a satisfaction survey, by the user, the FSL (126) may process completed satisfaction surveys to derive the target label(s). One of ordinary skill will appreciate that the FSL (126) may perform other functionalities without departing from the scope of the invention.

In one embodiment of the invention, the UDA (128) may refer to a computer process (i.e., an instance of a computer program—e.g., the USA (104)), which may execute on the underlying hardware of a client device (102A-102N), and may be designed and configured to address user discontent if exhibited by a user operating the client device (102A-102N). Addressing the issue of user discontent exhibited by a user of the client device (102A-102N) may include, but is not limited to, performing any subset or all of the following actions: (a) prompting the user with a customer support ticket that the user would need to consent to submit; (b) connecting the user with a customer support representative through a chat dialog box and/or a video feed (if the capability is available on the client device); (c) prompting the user with a more detailed satisfaction survey that the user would need to consent to submit; and (d) prompt the user with recommendations (e.g., termination of excess or stale computer programs, execution of diagnostic utilities, etc.) directed to facilitating client device performance.

In one embodiment of the invention, the OLM (114) may refer to may refer to a computer program, which may execute on the underlying hardware of the a client device (102A-102N), and may be designed and configured to implement a machine learning algorithm, which has been optimized through supervised learning. Supervised learning may refer to learning (or optimization) through the analysis of training examples and/or data. Further, the OLM (114) may focus on classifying and/or predicting user discontent with a given client device based on FSI samples from the given client device. To that extent, the OLM (114) may include functionality to: obtain one or more FSI samples; analyze the FSI sample(s) based on the learning model architecture implemented by the OLM (114); produce learning model output(s) based on analyzing the FSI sample(s); provide the produced learning model output(s) to the MOI (116); receive OLM (114) updates including new optimal learning model parameters and hyper-parameters; and adjust the implemented machine learning algorithm using the new optimal learning model parameters and hyper-parameters, thereby implementing an adjusted machine learning algorithm One of ordinary skill will appreciate that the OLM (114) may perform other functionalities without departing from the scope of the invention.

In one embodiment of the invention, the MOI (116) may refer to a computer program, which may execute on the underlying hardware of a client device (102A-102N), and may be designed and configured to interpret learning model outputs. To that extent, the MOI (116) may include functionality to: obtain learning model outputs from the OLM (114); interpret obtained learning model outputs to derive user discontent scores; and provide the derived user discontent scores to the UDA (128). One of ordinary skill will appreciate that the MOI (116) may perform other functionalities without departing from the scope of the invention.

FIG. 2 shows a flowchart describing a method for generating labeled feature set information (FSI) samples in accordance with one or more embodiments of the invention. The various steps outlined below may be performed by the user satisfaction agent (USA) executing on a client device (see e.g., FIG. 1A). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 2, in Step 200, feature set information (FSI) is aggregated. In one embodiment of the invention, FSI may refer to real-time captured data representing a set of features (i.e., measurable properties or characteristics) pertinent to user dissatisfaction (or discontent) classification and/or regression. That is, each feature may refer to a factor (or variable)—observed on the client device—that may, at least in part, cause or exhibit user discontent with the client device.

Examples of these features may include, but are not limited to: (a) a number of client device crashes recorded over a chosen time window, where more client device crashes tend to infer that the client device is not performing well, which leads to user discontent; (b) a number of user-initiated client device restarts recorded over a chosen time window, where more user-initiated client device restarts tend to infer that the client device is not performing well, which leads to user discontent; (c) input device (e.g., keyboard, mouse, etc.) usage patterns (described below) recorded over a chosen time window, where higher usage frequency and/or intensity tend to infer that a user, operating the client device, is stressed or angry, which may indicate user discontent; (d) operating system (OS) response time (i.e., an amount of time the OS may take to respond to a user request for a service on the client device) recorded over a chosen time window, where higher OS response times tend to infer that the user is waiting longer for a service to manifest following a request, which leads to user discontent; and (e) computer processor usage, while executing one or more computer programs, recorded over a chosen time window, where higher computer processor usage tends to infer that the client device is not performing well, which leads to user discontent. One of ordinary skill will appreciate that additional or alternative features may be used in user discontent classification and/or regression without departing from the scope of the invention.

In one embodiment of the invention, the above-mentioned input device usage patterns may refer to may refer to the observation of one or more additional features, which may record user interaction with one or more input devices (e.g., keyboard, mouse, etc.). Through observance of these additional features, the mental state (e.g., stressed versus relaxed) of a user may be predicted. For example, when it is logged that one or more keys of a keyboard is/are pressed intensely and rapidly, this observed action may be an indicator that the user is frustrated or angry. Examples of input device pertinent features, which may be observed, may include, but are not limited to, a number of mouse clicks recorded in a chosen time window, an average duration of a mouse click (i.e., average time elapsed between a button-down action and a button-up action), an average rate of mouse clicks recorded in a chosen time window, an average keystroke rate recorded in a chosen time window, an average duration of a keystroke (i.e., average time elapsed between a key-down action and a key-up action), an amount of mouse movement tracking the path and speed of the mouse cursor within the client device desktop environment, a frequency and/or intensity of keystrokes, and other input device dynamics.

In Step 202, an FSI sample is extracted from the FSI (aggregated in Step 200). In one embodiment of the invention, the FSI sample may represent a value snapshot of the various features, expressed in the FSI, for a given instance of time. The FSI sample may manifest as an N-dimensional vector or array (i.e., a flat data structure including N elements, where each element stores a numerical value quantifying a respective feature at the given instance of time), where N represents the number of features expressed in the FSI. Furthermore, extraction of an FSI sample may transpire based on a chosen periodicity, in response to an event, or through randomization.

In Step 204, the FSI sample (extracted in Step 202) is subsequently examined using one or more anomaly detection techniques. In one embodiment of the invention, anomaly (or outlier) detection may refer to the identification of abnormal observations, which tend to raise suspicion by differing significantly from a majority of the observations (i.e., normal observations). Usually, an identified anomaly in data (also referred herein as a data anomaly) may exhibit a strong correlation with a problem (e.g., the poor performance of a client device, or the poor mental state of a user, and, therefore, the discontent of the user with the client device).

In one embodiment of the invention, the employed anomaly detection technique(s) may be directed to univariate anomaly detection and/or multivariate anomaly detection. Univariate anomaly detection may refer to the identification of data anomalies in a single feature space (i.e., a chosen feature captured by the FSI sample). On the other hand, multivariate anomaly detection may refer to the identification of data anomalies across two or more feature spaces (i.e., two or more chosen features captured by the FSI sample). Examples of univariate or multivariate anomaly detection techniques may include, but are not limited to, methodologies based on z-score or extreme value analysis, probabilistic and statistical modeling, linear regression models, proximity based models, information theory models, and high dimensional sparse data analysis.

In Step 206, a determination is made as to whether data anomalies have been identified (or detected) based on examination of the FSI sample (in Step 204). Accordingly, in one embodiment of the invention, if it is determined that an abnormal observance has been identified with respect to one or more features, then data anomalies have been detected and the process may proceed to Step 208. On the other hand, in another embodiment of the invention, if it is alternatively determined that no abnormal observances have been identified with respect to at least one feature, then data anomalies have not been detected and the process ends.

In Step 208, after determining (in Step 206) that data anomalies have been observed across one or more feature values captured in the FSI sample (extracted in Step 202), a user of (or operating) the client device is prompted with a satisfaction survey. In one embodiment of the invention, the satisfaction survey may represent a questionnaire, visually presented to the user through the client device, which includes a set of questions directed to gauging user discontent at the given instance in time. By way of an example, the questionnaire may present a question prompting the user whether they are currently dissatisfied with the client device, which may be answered through a binary answer set (e.g., {yes, no}). By way of another example, the questionnaire may additionally or alternatively present another question prompting the user to quantify their dissatisfaction with the client device, which may be answered through a numerical or categorical scale answer set (e.g., {0 (satisfied), 1, 2, . . . , 10 (dissatisfied)} or {“very dissatisfied”, “dissatisfied”, “neutral”, “satisfied”, “very satisfied” }).

In Step 210, a determination is made as to whether the user completed the satisfaction survey (presented to the user in Step 208). The determination may entail observing user interaction with the satisfaction survey. That is, by way of an example, a user may have completed the satisfaction survey if all questions, prompted to the user, has been answered accordingly, followed by submission of the completed satisfaction survey through the toggling of a “submit” button instantiated on the satisfaction survey. By way of another example, a user may have disregarded (i.e., not completed) the satisfaction survey if a prompt window, presenting the satisfaction survey to the user, has been closed. Accordingly, in one embodiment of the invention, if it is determined that the user has submitted a completed satisfaction survey, then the process may proceed to Step 212. On the other hand, in another embodiment of the invention, if it is alternatively determined that the user has disregarded the satisfaction survey, then the process ends.

In Step 212, after determining (in Step 210) that the user has completed the satisfaction survey (presented to the user in Step 208), the completed satisfaction survey is processed. Specifically, in one embodiment of the invention, the answers selected (or provided) by the user, with respect to the prompted questions, may be mapped to (or used as) one or more target labels. A target label may refer to a discrete numerical or categorical value assigned to represent a class (i.e., in classification learning models) or a state (i.e., in regression learning models). For example, from the first exemplary question prompted to the user above, the answer given by the user (e.g., {yes} or {no}) may be mapped to: a “discontent” (e.g., categorical) or 1 (e.g., numerical) class if the user had answered with “yes”; or a “content” (e.g., categorical) or 0 (e.g., numerical) class if the user had alternatively answered with “no”. By way of the second exemplary question prompted to the user above, the answer given by the user (e.g., {an integer between and including 0 and 10}) may be mapped to a numerical value, within a similar numerical scale, to which a state (i.e., level) of discontent may be assigned.

In Step 214, a labeled FSI sample is generated. In one embodiment of the invention, the labeled FSI sample may represent a data container (e.g., a file format) within which the FSI sample (extracted in Step 202) and the target label(s) (obtained in Step 212) may be packaged together. Packaging may facilitate transmission (or transport) over the network, and consolidation in data storage. Thereafter, in Step 216, the labeled FSI sample (generated in Step 214) is transmitted, over the network, to a user satisfaction service (USS) (see e.g., FIG. 1A).

While FIG. 2 shows a configuration of steps for generating a labeled FSI sample, other methods may be used to generate labeled FSI samples without departing from the scope of the invention. For example, in one embodiment of the invention, a method omitting anomaly detection applied to the FSI sample may be used. In such an embodiment, following the extraction of the FSI sample, the user may be prompted with the satisfaction survey regardless of whether data anomalies had been identified in the FSI sample and, subsequently, from there, a labeled FSI sample may be generated, similar to as shown above, through processing of a completed satisfaction survey. That is, whereas the method outlined in FIG. 2 may be directed to capturing feature set data and target labels pertaining more to abnormal observances (e.g., users discontent with the client device), the alternative method briefly described above may be directed to capturing feature set data and target labels pertaining more to normal observances (e.g., users content/satisfied with the client device). Further, through the capturing of feature set data and target labels for both abnormal and normal observances, learning models optimized using labeled FSI samples may become more robust.

FIG. 3 shows a flowchart describing a method for optimizing a learning model in accordance with one or more embodiments of the invention. The various steps outlined below may be performed by the user satisfaction service (USS) (see e.g., FIG. 1A). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 3, in Step 300, one or more labeled feature set information (FSI) samples, from one or more client devices, respectively, is/are received. In one embodiment of the invention, a labeled FSI sample may represent a data container (e.g., a file format) within which a FSI sample (described above) and one or more target labels (described above), descriptive of the FSI sample, may be packaged. Further, the received labeled FSI sample(s) may encompass feature set data and target label(s) capturing abnormal observances (e.g., users discontent with their client devices), normal observances (e.g., users content/satisfied with their client devices), or any combination thereof.

In Step 302, a labeled sample pool (LSP) (see e.g., FIG. 1A) is subsequently updated using the labeled FSI sample(s) (received in Step 300). In one embodiment of the invention, the LSP may refer to a collection of labeled FSI samples, which may be aggregated from one or more client devices. The collection of labeled FSI samples, representative of the LSP, may include feature set data and target labels directed to a combination of abnormal and normal observances. Further, following the addition of the received labeled FSI sample(s) into the LSP, an updated LSP is obtained.

In Step 304, the updated LSP (obtained in Step 302) is partitioned into two labeled FSI sample subsets. In one embodiment of the invention, a first labeled FSI sample subset may include a first portion of the total cardinality (or number) of labeled FSI samples in the updated LSP, whereas a second labeled FSI sample subset may include a second portion (or remainder) of the total cardinality of labeled FSI samples in the updated LSP. Further, the first labeled FSI sample subset may also be referred herein as a learning model training set, while the second labeled FSI sample subset may also be referred herein as a learning model validation set.

In one embodiment of the invention, the ratio of labeled FSI samples forming the first labeled FSI sample subset to labeled FSI samples forming the second labeled FSI sample subset may be determined based on network administrator preferences. Specifically, these network administrator preferences may include a parameter—e.g., a Percentage of Data for Training (PDT) parameter—expressed through a numerical value that specifies the percentage of the updated LSP should be used for optimizing learning model parameters (described below).

In Step 306, one or more learning models is/are trained using the first labeled FSI sample subset (i.e., learning model training set) (obtained in Step 304). In one embodiment of the invention, recall that each labeled FSI sample packages a FSI sample and one or more target labels. If one target label is included, the target label may be relevant to either a classification learning model or a regression learning model. In contrast, if two target labels are included, a first target label may be relevant to a classification learning model, while a second target label may be relevant to a regression learning model. Accordingly, the classification learning model may be trained using labeled FSI samples (placed in the first labeled FSI sample subset), if any, that include a FSI sample and at least a target label directed to classification. Similarly, the regression learning model may be trained using labeled FSI samples (placed in the first labeled FSI sample subset), if any, that includes a FSI sample and at least a target label directed to regression.

In one embodiment of the invention, training the learning model(s), using the learning model training set, may result in the derivation of optimal learning model parameters. A learning model parameter may refer to a learning model configuration variable that may be adjusted (or optimized) during training of the respective learning model. Examples of a learning model parameter may include, but are not limited to, the weights in a neural network based classification learning model, the support vectors in a support vector machine based classification learning model, and the weights in a linear and/or non-linear based regression learning model. Further, the derivation of optimal learning model parameters may be possible through supervised learning, which refers to learning (or optimization) through the analyses of training examples and/or data.

In Step 308, the learning model(s) (trained in Step 306) is/are validated using the second labeled FSI sample subset (i.e., learning mode validation set) (obtained in Step 304). In one embodiment of the invention, a classification learning model may be validated using labeled FSI samples (placed in the second labeled FSI sample subset), if any, that include a FSI sample and at least a target label directed to classification. Meanwhile, regression learning models may be validated using labeled FSI samples (placed in the second labeled FSI sample subset), if any, that include a FSI sample and at least a target label directed to regression.

In one embodiment of the invention, validating the learning model(s), using the learning model validation set, may result in the derivation of optimal learning model hyper-parameters. A learning model hyper-parameter may refer to a learning model configuration variable that may be set before (and, subsequently, remains static throughout) the training process. Examples of a learning model hyper-parameter may include, but are not limited to, the learning rate for training neural network based classification learning models, the soft margin cost function defined in nonlinear support vector machine based classification learning models, and the learning rate associated with linear and/or non-linear based regression learning models.

In Step 310, a determination is made as to whether an optimized learning model (OLM) is active on the client device(s). An OLM may represent a computer program that implements a machine learning paradigm (e.g., a neural network, a decision tree, a support vector machine, a linear regression classifier, etc.), which has been optimized through supervised learning (described above), and may be designed and configured to predict user discontent with a given client device based on analyzing FSI samples. Further, an OLM may actively execute on the underlying hardware of each client device or, conversely, on the underlying hardware of a user satisfaction service (USS) (see e.g., FIG. 1A). Whether the OLM is active on the client device(s) or the USS may depend on network administrator preferences and/or a speed and accuracy of the OLM in outputting user discontent predictions. In one embodiment of the invention, if it is determined that the OLM is actively executing on the USS, then the process may proceed to Step 312. On the other hand, in another embodiment of the invention, if it is alternatively determined that the OLM is actively executing on the client device(s), then the process may alternatively proceed to Step 314.

In Step 312, after determining (in Step 310) that an OLM is actively executing on the USS, the OLM thereon is adjusted using the optimal learning model parameters (derived in Step 306) and the optimal learning model hyper-parameters (derived in Step 308). Specifically, in one embodiment of the invention, the existing (or previous) optimal learning model parameters and hyper-parameters, which defined the OLM, may be replaced with the new optimal learning model parameters and hyper-parameters. Further, upon adjusting the OLM, an adjusted OLM may be obtained.

In Step 314, after alternatively determining (in Step 310) that an OLM is actively executing on the client device(s), an OLM update is generated. Specifically, in one embodiment of the invention, the OLM update may represent a data container (e.g., a file format) that packages and, therefore, includes the optimal learning model parameters (derived in Step 306) and the optimal learning model hyper-parameters (derived in Step 308). Packaging may facilitate transmission (or transport) over the network, and consolidation in data storage. Thereafter, in Step 316, the OLM update (generated in Step 314) is deployed (i.e., transmitted), over the network, to the client device(s).

FIG. 4 shows a flowchart describing a method for processing sample analysis requests in accordance with one or more embodiments of the invention. The various steps outlined below may be performed by the user satisfaction service (USS) (see e.g., FIG. 1A). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 4, in Step 400, a sample analysis request is received from a client device. In one embodiment of the invention, the sample analysis request may represent a service request directed to data classification and/or regression analysis. Further, the sample analysis request may include a feature set information (FSI) sample. The FSI sample may represent a value snapshot of a set of features, expressed in the FSI observed on the client device, for a given instance of time. The FSI sample may manifest as an N-dimensional vector or array (i.e., a flat data structure including N elements, where each element stores a numerical value quantifying a respective feature at the given instance of time), where N represents the number of features expressed in the FSI.

In Step 402, the FSI sample (obtained by way of the sample analysis request received in Step 400) is analyzed using one or more optimized learning models (OLM). In one embodiment of the invention, an OLM may represent a computer program that implements a machine learning paradigm (e.g., a neural network, a decision tree, a support vector machine, a linear regression classifier, etc.), which has been optimized through supervised learning (described above), and may be designed and configured to predict user discontent with a given client device based on analyzing FSI samples submitted from the given client device. Furthermore, through analysis of the FSI sample using the OLM(s), a learning model output, from each OLM, is obtained. Accordingly, the learning model output may vary depending on the learning model (i.e., OLM) architecture. For example, if the learning model is directed to classification, the learning model output may take form as a numerical or categorical value that represents the class of which the input data (e.g., the FSI sample) is predicted to be a member. By way of another example, if the learning model is directed to regression, the learning model output may take form as a numerical value closest to a discrete numerical value assigned to a state with which the input data (e.g., the FSI sample) is predicted to be associated.

In Step 404, the learning model output(s) (obtained in Step 402) is/are subsequently interpreted, thus deriving a user discontent score. In one embodiment of the invention, the user discontent score may refer to a degree of confidence that a user of (or operating) the client device is discontent with the client device based on the FSI sample (obtained in Step 400).

In Step 406, a sample analysis response is generated. In one embodiment of the invention, the sample analysis response may represent a service response to the sample analysis request (received in Step 400). Further, the sample analysis response may be generated using, and thus, includes the user discontent score (derived in Step 404). Thereafter, in Step 408, the sample analysis response (generated in Step 406) is transmitted back to the client device which had submitted the sample analysis request.

FIG. 5 shows a flowchart describing a method for processing user feedback (also referred to as addressing user discontent) in accordance with one or more embodiments of the invention. The various steps outlined below may be performed by the user satisfaction agent (USA) executing on a client device (see e.g., FIG. 1A). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 5, in Step 500, feature set information (FSI) is aggregated. In one embodiment of the invention, FSI may refer to real-time captured data representing a set of features (i.e., measurable properties or characteristics) pertinent to user dissatisfaction (or discontent) classification and/or regression. That is, each feature may refer to a factor (or variable)—observed on the client device—that may, at least in part, cause or exhibit user discontent with the client device.

Examples of these features may include, but are not limited to: (a) a number of client device crashes recorded over a chosen time window, where more client device crashes tend to infer that the client device is not performing well, which leads to user discontent; (b) a number of user-initiated client device restarts recorded over a chosen time window, where more user-initiated client device restarts tend to infer that the client device is not performing well, which leads to user discontent; (c) input device (e.g., keyboard, mouse, etc.) usage patterns (described below) recorded over a chosen time window, where higher usage frequency and/or intensity tend to infer that a user, operating the client device, is stressed or angry, which may indicate user discontent; (d) operating system (OS) response time (i.e., an amount of time the OS may take to respond to a user request for a service on the client device) recorded over a chosen time window, where higher OS response times tend to infer that the user is waiting longer for a service to manifest following a request, which leads to user discontent; and (e) computer processor usage, while executing one or more computer programs, recorded over a chosen time window, where higher computer processor usage tends to infer that the client device is not performing well, which leads to user discontent. One of ordinary skill will appreciate that additional or alternative features may be used in user discontent classification and/or regression without departing from the scope of the invention.

In one embodiment of the invention, the above-mentioned input device usage patterns may refer to the observation of one or more additional features, which may record user interaction with one or more input devices (e.g., keyboard, mouse, etc.). Through observance of these additional features, the mental state (e.g., stressed versus relaxed) of a user may be predicted. For example, when it is logged that one or more keys of a keyboard is/are pressed intensely and rapidly, this observed action may be an indicator that the user is frustrated or angry. Examples of input device pertinent features, which may be observed, may include, but are not limited to, a number of mouse clicks recorded in a chosen time window, an average duration of a mouse click (i.e., average time elapsed between a button-down action and a button-up action), an average rate of mouse clicks recorded in a chosen time window, an average keystroke rate recorded in a chosen time window, an average duration of a keystroke (i.e., average time elapsed between a key-down action and a key-up action), an amount of mouse movement tracking the path and speed of the mouse cursor within the client device desktop environment, a frequency and/or intensity of keystrokes, and other input device dynamics.

In Step 502, an FSI sample is extracted from the FSI (aggregated in Step 500). In one embodiment of the invention, the FSI sample may represent a value snapshot of the various features, expressed in the FSI, for a given instance of time. The FSI sample may manifest as an N-dimensional vector or array (i.e., a flat data structure including N elements, where each element stores a numerical value quantifying a respective feature at the given instance of time), where N represents the number of features expressed in the FSI. Furthermore, extraction of an FSI sample may transpire based on a chosen periodicity, in response to an event, or through randomization.

In Step 504, a determination is made as to whether an optimized learning model (OLM) is active on the client device(s). An OLM may represent a computer program that implements a machine learning paradigm (e.g., a neural network, a decision tree, a support vector machine, a linear regression classifier, etc.), which has been optimized through supervised learning (described above), and may be designed and configured to predict user discontent with a given client device based on analyzing FSI samples. Further, an OLM may actively execute on the underlying hardware of each client device or, conversely, on the underlying hardware of a user satisfaction service (USS) (see e.g., FIG. 1A). Whether the OLM is active on the client device(s) or the USS may depend on network administrator preferences and/or a speed and accuracy of the OLM in outputting user discontent predictions. In one embodiment of the invention, if it is determined that the OLM is actively executing on the USS, then the process may proceed to Step 506. On the other hand, in another embodiment of the invention, if it is alternatively determined that the OLM is actively executing on the client device(s), then the process may alternatively proceed to Step 512.

In Step 506, after determining (in Step 504) that an OLM is actively executing on the USS, a sample analysis request is generated. In one embodiment of the invention, the sample analysis request may represent a service request directed to data classification and/or regression analysis. Further, the sample analysis request may include the FSI sample (extracted in Step 502).

In Step 508, the sample analysis request (generated in Step 506) is subsequently transmitted, over a network, to the USS. In Step 510, following the transmission of the sample analysis request, a sample analysis response is received from the USS. In one embodiment of the invention, the sample analysis response may represent a service response to the sample analysis request (transmitted in Step 508). Further, the sample analysis response may include a user discontent score therein. The user discontent score may refer to a degree of confidence that a user of (or operating) the client device is discontent with the client device based on the FSI sample (extracted in Step 502).

In Step 512, after alternatively determining (in Step 504) that an OLM is actively executing on the client device(s) instead, the FSI sample (extracted in Step 502) is analyzed, locally on the client device, using one or more OLM(s). In one embodiment of the invention, through analysis of the FSI sample using the OLM(s), a learning model output, from each OLM, is obtained. Accordingly, the learning model output may vary depending on the learning model (i.e., OLM) architecture. For example, if the learning model is directed to classification, the learning model output may take form as a numerical or categorical value that represents the class of which the input data (e.g., the FSI sample) is predicted to be a member. By way of another example, if the learning model is directed to regression, the learning model output may take form as a numerical value closest to a discrete numerical value assigned to a state with which the input data (e.g., the FSI sample) is predicted to be associated.

In Step 514, the learning model output(s) (obtained in Step 512) is/are subsequently interpreted, thus deriving a user discontent score (defined above). Thereafter, in Step 516, following either obtaining the user discontent score (in Step 510) or deriving the user discontent score (in Step 514), the exhibited user discontent with the client device is addressed based on the user discontent score. In one embodiment of the invention, addressing the issue of user discontent exhibited by a user of the client device may include, but is not limited to, performing any subset or all of the following actions: (a) prompting the user with a customer support ticket that the user would need to consent to submit; (b) connecting the user with a customer support representative through a chat dialog box and/or a video feed (if the capability is available on the client device); (c) prompting the user with a more detailed satisfaction survey that the user would need to consent to submit; and (d) prompt the user with recommendations (e.g., termination of excess or stale computer programs, execution of diagnostic utilities, etc.) directed to facilitating client device performance.

FIG. 6 shows a computing system in accordance with one or more embodiments of the invention. The computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment of the invention, the computer processor(s) (602) may be an integrated circuit for processing instructions. For example, the computer processor(s) may be one or more cores or micro-cores of a central processing unit (CPU) and/or a graphics processing unit (GPU). The computing system (600) may also include one or more input devices (610), such as a touchscreen, keyboard, mouse, microphone, touchpad, electronic pen, or any other type of input device. Further, the communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

In one embodiment of the invention, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for processing user feedback on client devices, comprising:
aggregating feature set information (FSI) for a client device;
extracting a first FSI sample from the FSI;
obtaining a first user discontent score using at least the first FSI sample;
identifying user discontent exhibited on the client device based on the first user discontent score; and
addressing the user discontent exhibited on the client device by performing one selected from a group consisting of:
prompting a user of the client device with a customer support ticket,
connecting the user of the client with a customer support representative,
prompting the user of the client device with a satisfaction survey, and
prompting the user of the client device with recommendations directed to restoring client device performance.

2. The method of claim 1, wherein the FSI comprises a number of client device crashes recorded over a chosen time window, a number of user-initiated client device restarts recorded over the chosen time window, input device usage patterns recorded over the chosen time window, operating system (OS) response time recorded over the chosen time window, and computer processor usage recorded over the chosen time window.

3. The method of claim 1, wherein obtaining the first user discontent score using at least the first FSI sample, comprises:
analyzing the first FSI sample using an optimized learning model (OLM), to obtain a learning model output; and
interpreting the learning model output, to derive the first user discontent score.

4. The method of claim 3, further comprising:
prior to extracting the first FSI sample from the FSI:
receiving an OLM update comprising a set of optimal learning model parameters and a set of optimal learning model hyper-parameters; and
adjusting the OLM using the set of optimal learning model parameters and the set of optimal learning model hyper-parameters, to obtain an adjusted OLM,
wherein the first FSI sample is instead analyzed using the adjusted OLM, to obtain the learning model output.

5. The method of claim 4, further comprising:
prior to receiving the OLM update:
extracting a second FSI sample from the FSI;
examining the second FSI sample, to detect a data anomaly therein; and
prompting, based on detecting the data anomaly, a user operating the client device with a satisfaction survey.

6. The method of claim 5, further comprising:
obtaining a completed satisfaction survey submitted by the user;
processing the completed satisfaction survey, to obtain a target label;
generating a labeled FSI sample using the second FSI sample and the target label; and
transmitting the labeled FSI sample to a user satisfaction service (USS),
wherein the OLM update is received from the USS, at least in part, in response to transmission of the labeled FSI sample.

7. The method of claim 1, wherein obtaining the first user discontent score using at least the first FSI sample, comprises:
generating a sample analysis request comprising the first FSI sample;
transmitting the sample analysis request to a user satisfaction service (USS); and
receiving, in response to the sample analysis request and from the USS, a sample analysis response comprising the first user discontent score.

8. A system, comprising:
a processor;
memory comprising instructions, which when executed by the processor, enable the system to perform a method, the method comprising:
aggregating feature set information (FSI) for the client device;
extracting a first FSI sample from the FSI;
obtaining a first user discontent score using at least the first FSI sample;
identifying user discontent exhibited on the client device based on the first user discontent score; and
addressing the user discontent exhibited on the client device by performing one selected from a group consisting of:
prompting a user of the client device with a customer support ticket,
connecting the user of the client with a customer support representative,
prompting the user of the client device with a satisfaction survey, and
prompting the user of the client device with recommendations directed to restoring client device performance.

9. The system of claim 8, wherein obtaining the first user discontent score using at least the first FSI sample, comprises:
analyzing the first FSI sample using an optimized learning model (OLM), to obtain a learning model output; and
interpreting the learning model output, to derive the first user discontent score.

10. The system of claim 9, the method further comprising:
prior to extracting the first FSI sample from the FSI:
receiving an OLM update comprising a set of optimal learning model parameters and a set of optimal learning model hyper-parameters; and
adjusting the OLM using the set of optimal learning model parameters and the set of optimal learning model hyper-parameters, to obtain an adjusted OLM,
wherein the first FSI sample is instead analyzed using the adjusted OLM, to obtain the learning model output.

11. The system of claim 10, the method further comprising:
prior to receiving the OLM update:
extracting a second FSI sample from the FSI;
examining the second FSI sample, to detect a data anomaly therein; and
prompting, based on detecting the data anomaly, a user operating the client device with a satisfaction survey.

12. The system of claim 11, the method further comprising:
obtaining a completed satisfaction survey submitted by the user;
processing the completed satisfaction survey, to obtain a target label;
generating a labeled FSI sample using the second FSI sample and the target label; and
transmitting the labeled FSI sample to a user satisfaction service (USS),
wherein the OLM update is received from the USS, at least in part, in response to transmission of the labeled FSI sample.

13. The system of claim 8, wherein obtaining the first user discontent score using at least the first FSI sample, comprises:
generating a sample analysis request comprising the first FSI sample;
transmitting the sample analysis request to a user satisfaction service (USS); and
receiving, in response to the sample analysis request and from the USS, a sample analysis response comprising the first user discontent score.

14. A non-transitory computer readable medium (CRM) comprising computer readable program code, which when executed by a computer processor on a client device, enables the computer processor to:
aggregate feature set information (FSI) for the client device;
extract a first FSI sample from the FSI;
obtain a first user discontent score using at least the first FSI sample;
identify user discontent exhibited on the client device based on the first user discontent score; and
address the user discontent exhibited on the client device by performing one selected from a group consisting of:
prompting a user of the client device with a customer support ticket,
connecting the user of the client with a customer support representative,
prompting the user of the client device with a satisfaction survey, and
prompting the user of the client device with recommendations directed to restoring client device performance.

15. The non-transitory CRM of claim 14, wherein FSI comprises a number of client device crashes recorded over a chosen time window, a number of user-initiated client device restarts recorded over the chosen time window, input device usage patterns recorded over the chosen time window, operating system (OS) response time recorded over the chosen time window, and computer processor usage recorded over the chosen time window.

16. The non-transitory CRM of claim 14, further comprising computer readable program code, which when executed by the computer processor on the client device, enables the computer processor to:
obtain the first user discontent score using at least the first FSI sample, by:
analyzing the first FSI sample using an optimized learning model (OLM), to obtain a learning model output; and
interpreting the learning model output, to derive the first user discontent score.

17. The non-transitory CRM of claim 16, further comprising computer readable program code, which when executed by the computer processor on the client device, enables the computer processor to:
prior to extraction of the first FSI sample from the FSI:
receive an OLM update comprising a set of optimal learning model parameters and a set of optimal learning model hyper-parameters; and
adjust the OLM using the set of optimal learning model parameters and the set of optimal learning model hyper-parameters, to obtain an adjusted OLM,
wherein the first FSI sample is instead analyzed using the adjusted OLM, to obtain the learning model output.

18. The non-transitory CRM of claim 17, further comprising computer readable program code, which when executed by the computer processor on the client device, enables the computer processor to:
prior to reception of the OLM update:
extract a second FSI sample from the FSI;
examine the second FSI sample, to detect a data anomaly therein; and
prompt, based on detecting the data anomaly, a user operating the client device with a satisfaction survey.

19. The non-transitory CRM of claim 18, further comprising computer readable program code, which when executed by the computer processor on the client device, enables the computer processor to:
obtain a completed satisfaction survey submitted by the user;
process the completed satisfaction survey, to obtain a target label;
generate a labeled FSI sample using the second FSI sample and the target label; and
transmit the labeled FSI sample to a user satisfaction service (USS),
wherein the OLM update is received from the USS, at least in part, in response to transmission of the labeled FSI sample.

20. The non-transitory CRM of claim 14, further comprising computer readable program code, which when executed by the computer processor on the client device, enables the computer processor to:
obtain the first user discontent score using at least the first FSI sample, by:
generating a sample analysis request comprising the first FSI sample;
transmitting the sample analysis request to a user satisfaction service (USS); and
receiving, in response to the sample analysis request and from the USS, a sample analysis response comprising the first user discontent score.
